(19) United States
(12) Patent Application Publication
(10) Pub. No.: US 2020/0241606 A1
(43) Pub. Date: Jul. 30, 2020

(54) MULTIPLEX SENSING CORE AND INPUT DEVICE

(71) Applicant: Acer Incorporated, New Taipei City (TW)

(72) Inventors: Jia-Yu Lin, New Taipei City (TW); Chih-Chiang Chen, New Taipei City (TW)

(73) Assignee: Acer Incorporated, New Taipei City (TW)

(21) Appl. No.: 16/531,131

(22) Filed: Aug. 5, 2019

(30) Foreign Application Priority Data
Jan. 24, 2019 (TW) 108102654

(51) Int. Cl. G06F 1/16; G06F 3/02; G06F 3/01

(52) U.S. Cl. CPC G06F 1/1684; G06F 3/016; G06F 3/0202

(57) ABSTRACT

A multiplex sensing core and an input device are provided. The multiplex sensing core includes a sensing unit array, a first combining mechanism, and a microcontroller. The sensing unit array includes a plurality of sensing units. The first combining mechanism is combined with a second combining mechanism of an input device housing, so that at least one of the sensing units is disposed corresponding to a plurality of buttons of the input device housing. The microcontroller is coupled to the sensing units. The microcontroller enables the at least one of the sensing units corresponding to the buttons of the input device housing, and disables other sensing units that do not correspond to the buttons of the input device housing. The input device includes the multiplex sensing core and the input device housing.

### CROSS-REFERENCE TO RELATED APPLICATION

This application claims the priority benefit of Taiwan application serial no. 108102654, filed on Jan. 24, 2019. The entirety of the above-mentioned patent application is hereby incorporated by reference herein and made a part of this specification.

### BACKGROUND

### Technical Field

The disclosure relates to a device, and more particularly to a multiplex sensing core and an input device applied in a reality apparatus.

### Related Art

Generally, a controller for virtual reality (VR), augmented reality (AR) or mixed reality (MR) may be designed to have input devices in various forms according to different situations and needs. For example, the controller may be of a specific shape such as a handle, a steering wheel, a weapon or the like. Most of the input devices differ little in manipulation and function, and mainly differ in shape and appearance. However, in order to meet various different situations and needs, a user has to purchase input devices of different forms, resulting in waste of resources and increased use costs. In view of this, with respect to how to design an input device having diverse input functions and manipulation effects, several embodiments will be proposed below as solutions.

### SUMMARY

The disclosure provides a multiplex sensing core and an input device which may be applied in a reality apparatus, wherein the multiplex sensing core may be combined with various removable and replaceable input device housings to provide diverse input functions and manipulation effects.

The multiplex sensing core of the disclosure is adapted to be combined with an input device housing. The multiplex sensing core includes a sensing unit array, a first combining mechanism, and a microcontroller. The sensing unit array includes a plurality of sensing units. The first combining mechanism is configured to be combined with a second combining mechanism of the input device housing, so that at least one of the sensing units is disposed corresponding to a plurality of buttons of the input device housing. The microcontroller is coupled to the sensing units. The microcontroller is configured to enable the at least one of the sensing units corresponding to the buttons of the input device housing, and to disable other sensing units that do not correspond to the buttons of the input device housing.

In an embodiment of the disclosure, the multiplex sensing core further includes a mode selection unit. The mode selection unit is coupled to the microcontroller and includes a plurality of mode pins. The microcontroller determines to enable the at least one of the sensing units according to a coupling result between at least one of the mode pins and at least one selection pin of the input device housing.

In an embodiment of the disclosure, the multiplex sensing core further includes a memory unit. The memory unit is coupled to the microcontroller. The memory unit is configured to record a lookup table. The microcontroller reads the lookup table according to the coupling result between the at least one of the mode pins and the at least one selection pin of the input device housing, so as to determine to enable the at least one of the sensing units.

In an embodiment of the disclosure, the multiplex sensing core further includes a first connector. When the multiplex sensing core is combined with the input device housing, the first connector is coupled to a second connector of the input device housing. The second connector of the input device housing is coupled to a third connector of a position sensor, so that the microcontroller drives the position sensor.

In an embodiment of the disclosure, the multiplex sensing core further includes another sensing unit. The other sensing unit is coupled to the microcontroller. When the multiplex sensing core is combined with the input device housing, the other sensing unit is disposed corresponding to a side frame button of the input device housing.

In an embodiment of the disclosure, the microcontroller determines a degree of force applied to the side frame button according to a capacitance value variation between the other sensing unit and the side frame button.

In an embodiment of the disclosure, the multiplex sensing core further includes a core column. The sensing unit array is disposed surrounding the core column.

In an embodiment of the disclosure, the multiplex sensing core further includes a plurality of light emitting units. The light emitting units are coupled to the microcontroller and disposed corresponding to the sensing units.

In an embodiment of the disclosure, when the input device housing is combined with both the multiplex sensing core and another multiplex sensing core, the microcontroller determines an input mode according to corresponding disposition between the at least one of the sensing units of the multiplex sensing core and the buttons of the input device housing and between at least one of another plurality of sensing units of the other multiplex sensing core and another plurality of buttons of the input device housing.

In an embodiment of the disclosure, the multiplex sensing core further includes a communication unit. The communication unit is coupled to the microcontroller. The microcontroller communicates with an external reality apparatus via the communication unit, and, according to an operation result of the buttons of the input device housing corresponding to the at least one of the sensing units, outputs an operation command to the reality apparatus.

The input device of the disclosure includes a multiplex sensing core and an input device housing. The multiplex sensing core includes a sensing unit array, a first combining mechanism, and a microcontroller. The sensing unit array includes a plurality of sensing units. The microcontroller is coupled to the sensing units. The input device housing includes a plurality of buttons and a second combining mechanism. The first combining mechanism of the multiplex sensing core is combined with the second combining mechanism of the input device housing, so that at least one of the sensing units is disposed corresponding to the buttons. The microcontroller enables the at least one of the sensing units corresponding to the buttons, and disables other sensing units that do not correspond to the buttons.

Based on the above, in the multiplex sensing core and the input device of the disclosure, by disposing the sensing unit array on the multiplex sensing core, the multiplex sensing core can be selectively combined with different input device housings by the user. Therefore, the multiplex sensing core and the input device of the disclosure provide diverse input functions and manipulation effects.

To make the above features and advantages of the disclosure more comprehensible, examples accompanied with drawings are described in detail as follows.

### BRIEF DESCRIPTION OF THE DRAWINGS

FIG. 1 is a schematic circuit diagram of a multiplex sensing core according to an embodiment of the disclosure.

FIG. 2 is a schematic top view of an input device according to the embodiment of FIG. 1 of the disclosure.

FIG. 3 is a schematic diagram of a structure of a button and a sensing unit according to an embodiment of the disclosure.

FIG. 4 is a schematic diagram of a structure of a button and a sensing unit according to another embodiment of the disclosure.

FIG. 5 is a schematic top view of an input device according to an embodiment of the disclosure.

FIG. 6 is a schematic side view of the input device according to the embodiment of FIG. 5 of the disclosure.

FIG. 7 is a schematic exploded view of the input device according to the embodiment of FIG. 5 of the disclosure.

FIG. 8 is a schematic diagram of a structure of a side frame button and a sensing unit according to the embodiment of FIG. 5 of the disclosure.

FIG. 9 is a schematic diagram of a capacitance value variation according to the embodiment of FIG. 8 of the disclosure.

FIG. 10 is a schematic diagram of a multiplex sensing core according to another embodiment of the disclosure.

FIG. 11 is a schematic block diagram of an input device according to another embodiment of the disclosure.

### DESCRIPTION OF THE EMBODIMENTS

The term “coupled” used in this specification (including claims) may refer to any direct or indirect connection means. For example, “a first device is coupled to a second device” herein should be interpreted as “the first device is directly coupled to the second device” or “the first device is indirectly coupled to the second device through other devices, guide wires or certain connection means.” Moreover, wherever appropriate in the drawings and embodiments, elements/components/steps with the same reference numerals represent the same or similar parts. Elements/components/steps with the same reference numerals or names in different embodiments may be cross-referenced.

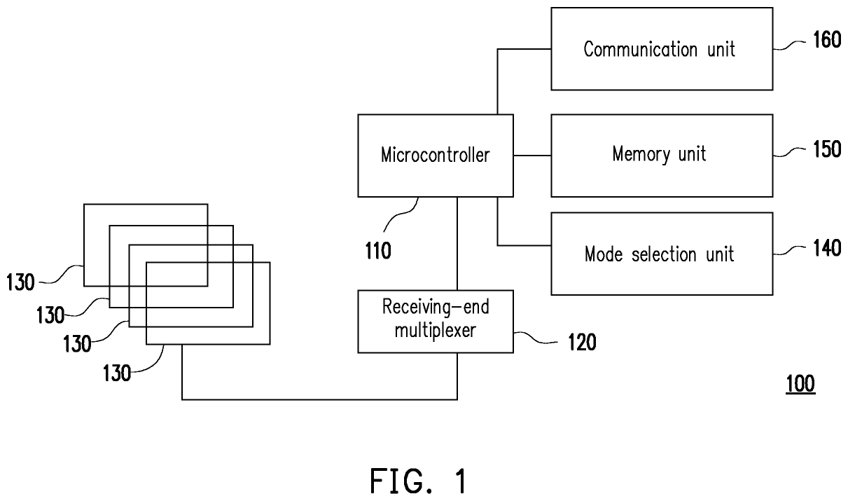

FIG. 1 is a schematic circuit diagram of a multiplex sensing core according to an embodiment of the disclosure. Referring to FIG. 1, a multiplex sensing core 100 includes a microcontroller 110, a receiving-end multiplexer 120, a plurality of sensing units 130, a mode selection unit 140, a memory unit 150, and a communication unit 160. The multiplex sensing core 100 is adapted to be combined with various input device housings. The microcontroller 110 is coupled to the receiving-end multiplexer 120, the sensing units 130, the mode selection unit 140, the memory unit 150 and the communication unit 160. In the present embodiment, the microcontroller 110 is coupled to the sensing units 130 via the receiving-end multiplexer 120, and determines to enable at least one of the sensing units 130 according to mode selection information provided by the mode selection unit 140. The receiving-end multiplexer 120 drives the sensing units 130 to transmit signals to the sensing units 130 simultaneously or in a time-division manner. In other words, by being combined with different input device housings, the multiplex sensing core 100 of the present embodiment senses a result of a user's operation on the input device housings using at least one of the corresponding sensing units 130. The multiplex sensing core of the present embodiment may be combined with a specific input device housing to become a specific input device and may be applied in a reality apparatus.

In the present embodiment, the microcontroller 110 may include a central processing unit (CPU) having data processing and computing functions, or other programmable general purpose or special purpose microprocessor, a digital signal processor (DSP), a programmable controller, an application specific integrated circuit (ASIC), a programmable logic device (PLD), other similar processing device or a combination of the foregoing devices. Furthermore, the memory unit 150 may be a memory configured to store a lookup table (LUT) described in the embodiments of the disclosure and an algorithm required to implement the disclosure so as to allow the microcontroller 110 to read and executed them.

In the present embodiment, the communication unit 160 may include a wireless or wired communication interface, for example, a Wi-Fi communication interface, a Bluetooth communication interface, a local area network interface, a Universal Serial Bus (USB) interface, or other wireless or wired communication interface. The disclosure is not limited thereto. In the present embodiment, the microcontroller 110 communicates with an external reality apparatus via the communication unit 160, and, according to an operation result of a plurality of buttons of the input device housing corresponding to the at least one of the sensing units 130, outputs an operation command to the reality apparatus. The reality apparatus is, for example, a virtual reality (VR) apparatus, an augmented reality (AR) apparatus, or a mixed reality (MR) apparatus. In other words, the user may combine the multiplex sensing core 100 with the specific input device housing according to different operation requirements, and use the resultant as a VR, AR or MR controller.

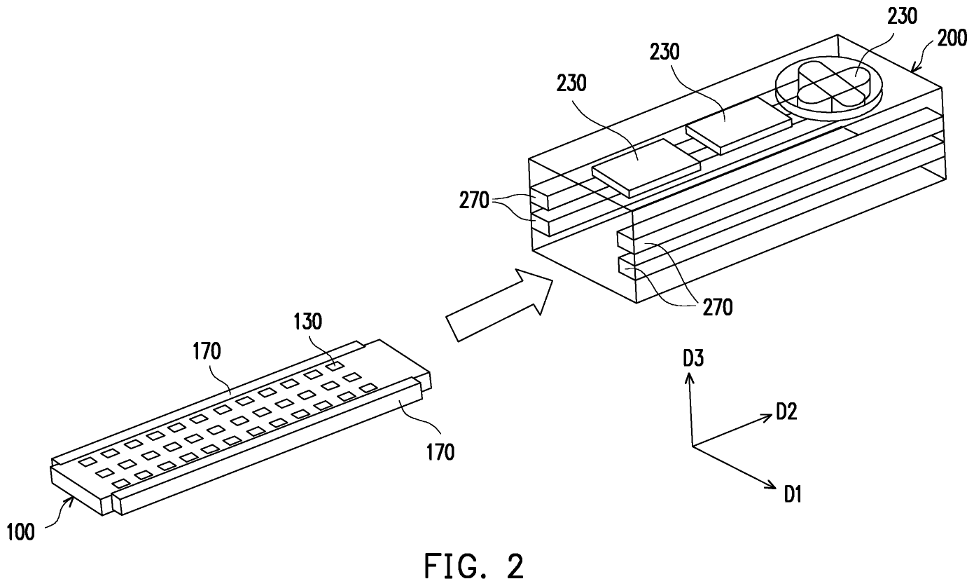

FIG. 2 is a schematic top view of an input device according to the embodiment of FIG. 1 of the disclosure. Referring to FIG. 1 and FIG. 2, in the present embodiment, the multiplex sensing core 100 further includes a first combining mechanism 170. An input device housing 200 includes a plurality of buttons 230 and a second combining mechanism 270. The first combining mechanism 170 may be a slider mechanism and the second combining mechanism 270 may be a slide rail mechanism. The user may combine the first combining mechanism 170 of the multiplex sensing core 100 with the second combining mechanism 270 of the input device housing 200 along a second direction D2. A first direction D1, the second direction D2, and a third direction D3 are perpendicular to each other. In the present embodiment, the input device housing 200 is, for example, a handle, a steering wheel, a weapon, or a device housing of a specific shape, and the disclosure is not limited thereto.

In the present embodiment, when the multiplex sensing core 100 has been combined with the input device housing 200, some of the sensing units 130 are disposed corresponding to the buttons 230 of the input device housing 200 in the third direction D3. In the present embodiment, the microcontroller 110 enables at least one of the sensing units 130 corresponding to the buttons 230 of the input device housing 200, and disables other sensing units 130 that do not correspond to the buttons 230 of the input device housing 200. In other words, when the multiplex sensing core 100 and the input device housing 200 have been combined together, the multiplex sensing core 100 only needs to enable some of the sensing units 130 without having to enable all the sensing units 130, thereby reducing power consumption.

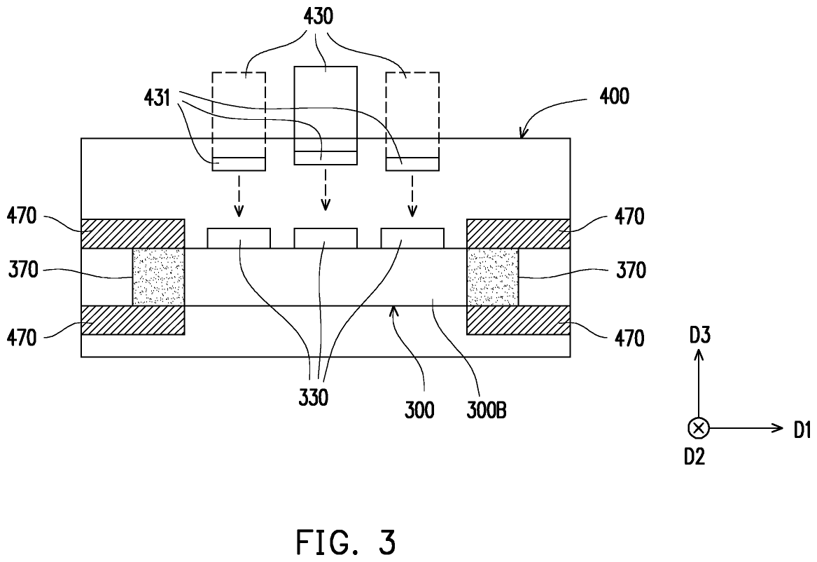

FIG. 3 is a schematic diagram of a structure of a button and a sensing unit according to an embodiment of the disclosure. Referring to FIG. 3, in the present embodiment, a plurality of buttons 430 may be mechanical buttons. A multiplex sensing core 300 includes a circuit board 300B. A plurality of sensing units 330 are disposed on the circuit board 300B, and a first combining mechanism 370 is disposed on both sides of the circuit board 300B. An input device housing 400 includes the buttons 430 and a second combining mechanism 470. The buttons 430 are displaceable in the third direction D3. When the multiplex sensing core 300 has been mounted in the second direction D2 into the input device housing 400, at least one of the buttons 430 may correspond to at least one of the sensing units 330.

In the present embodiment, the sensing units 330 and the buttons 430 may constitute a press-type sensing device. In this regard, the sensing units 330 may be electrodes, and the buttons 430 may include a plurality of electrodes 431. The sensing units 330 and the electrodes 431 are disposed corresponding to each other in the third direction D3. That is, when the user presses one of the buttons 430, one of the sensing units 330 contacts the corresponding electrode 431 of one of the buttons 430, and the one of the sensing units 330 may output a trigger signal to the microcontroller.

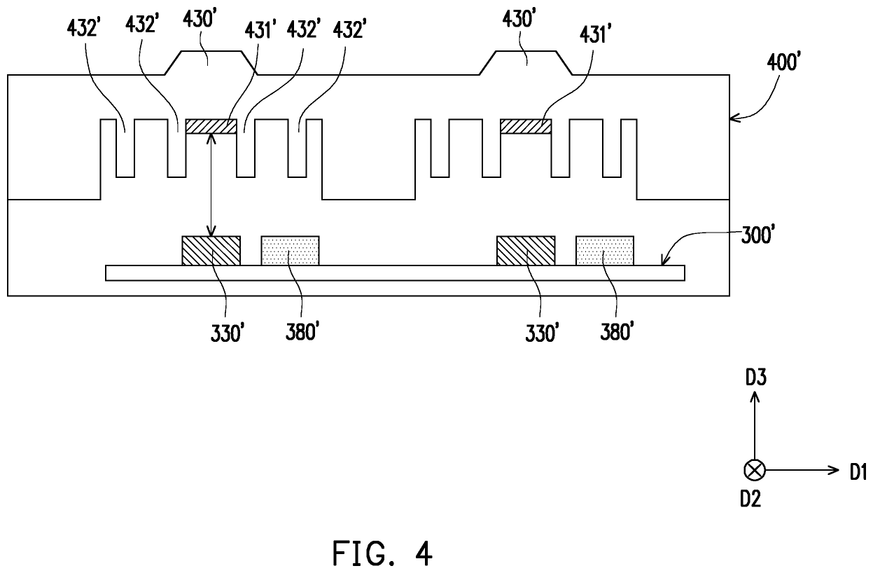

FIG. 4 is a schematic diagram of a structure of a button and a sensing unit according to another embodiment of the disclosure. Referring to FIG. 4, in the present embodiment, a plurality of buttons 430′ may be membrane buttons. A multiplex sensing core 300′ includes a circuit board and a first combining mechanism (not shown). The circuit board is, for example, a printed circuit board (PCB) or a flexible printed circuit board (FPCB). A plurality of sensing units 330′ are disposed on the circuit board. An input device housing 400′ includes the buttons 430′, a second combining mechanism (not shown) and a plurality of support members 432′. The buttons 430′ are displaceable in the third direction D3. When the multiplex sensing core 300′ has been mounted in the second direction D2 into the input device housing 400′, at least one of the buttons 430′ may correspond to at least one of the sensing units 330′. In the present embodiment, a plurality of light emitting units 380′ may further be disposed on the multiplex sensing core 300′. The light emitting units 380′ are coupled to the microcontroller. The light emitting units 380′ are disposed corresponding to the sensing units 330′. The light emitting units 380′ may provide information such as reminders, warnings, decorations or illumination so as to effectively increase recognizability of the buttons 430′.

In the present embodiment, the sensing units 330′ may be electrodes, and the buttons 430′ may include a plurality of electrodes 431′. The respective capacitance value variation between the sensing units 330′ and the electrodes 431′ of the buttons 430′ is determined by a distance between the sensing units 330′ and the electrodes 431′. That is, the input device housing 400′ may have the electrodes 431′ disposed therein, and the electrodes 431′ may be flexible sensors. The electrodes 431′ may be printed onto a substrate by a continuous roll-to-roll printing process, and the substrate is then attached to the inside of the input device housing 400′.

Thus, when the user presses one of the buttons 430′, one of the sensing units 330′ approaches the corresponding electrode 431′ of one of the buttons 430′, and the one of the sensing units 330′ may output a capacitance value variation result to the microcontroller, so that the microcontroller effectively senses whether the one of the buttons 430′ is pressed. However, the disclosure is not limited thereto. In addition, since the support members 432′ of the present embodiment may be elastic members and abut against the circuit board, when a pressing pressure is applied to the buttons 430′ respectively, the support members 432′ enable the buttons 430′ to return to their original positions.

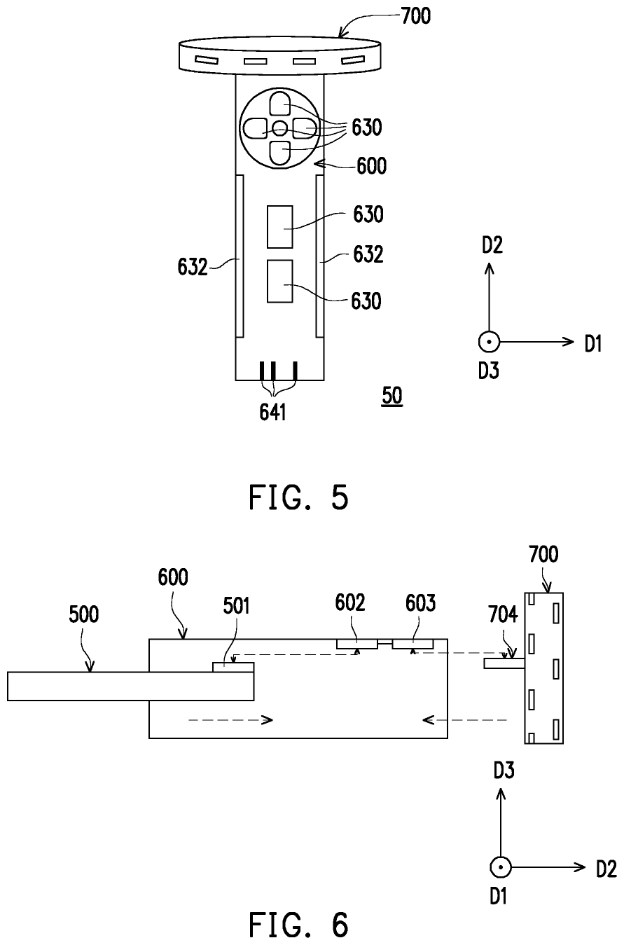

FIG. 5 is a schematic top view of an input device according to an embodiment of the disclosure. Referring to FIG. 5, an input device 50 includes a multiplex sensing core (not shown), an input device housing 600, and a position sensor 700. In the present embodiment, the input device housing 600 may further be combined with the position sensor 700 to provide positioning information or displacement information. The input device housing 600 includes a plurality of buttons 630, a plurality of side frame buttons 632, and a plurality of selection pins 641. In the present embodiment, the side frame buttons 632 sense a degree of force applied by the user. In the present embodiment, the selection pins 641 may be coupled to some of a plurality of mode pins of the multiplex sensing core to generate mode selection information, so that the multiplex sensing core enables a plurality of sensing units corresponding to the buttons 630 and the side frame buttons 632.

FIG. 6 is a schematic side view of the input device according to the embodiment of FIG. 5 of the disclosure. Referring to FIG. 5 and FIG. 6, in the present embodiment, a multiplex sensing core 500 may further include a connector 501. The input device housing 600 may further include connectors 602 and 603. The position sensor 700 may include a connector 704. In the present embodiment, when the multiplex sensing core 500 is combined with the input device housing 600 and the position sensor 700, the connector 501 is coupled to the connector 602 of the input device housing 600, and the connector 603 of the input device housing 600 is coupled to the connector 704 of the position sensor 700, so that the microcontroller of the multiplex sensing core 500 effectively drives the position sensor 700 to acquire the positioning information. In the present embodiment, the connectors 501, 602, 603 and 704 may each be a connection port having a plurality of metal pins.

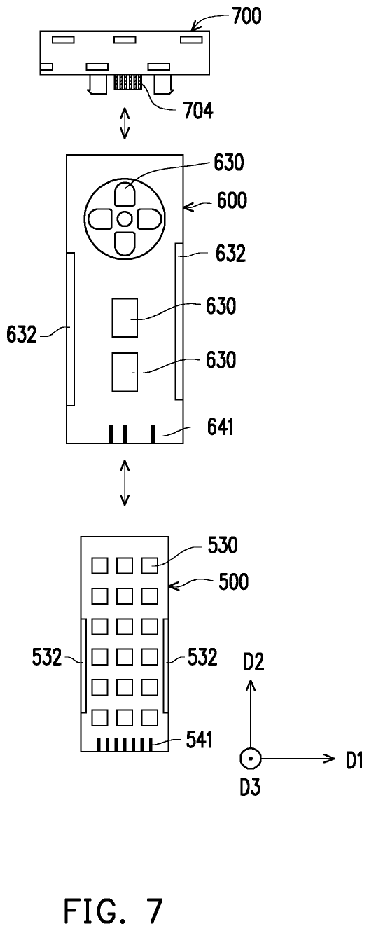

FIG. 7 is a schematic exploded view of the input device according to the embodiment of FIG. 5 of the disclosure. Referring to FIG. 5 and FIG. 7, the multiplex sensing core 500 includes a plurality of sensing units 530 and 532 and a plurality of mode pins 541, and the sensing units 530 are arrayed to form a sensing unit array. Moreover, when the multiplex sensing core 500 has been combined with the input device housing 600, the selection pins 641 may be coupled to some of the mode pins 541. Thus, the multiplex sensing core 500 may determine an enable mode of the sensing units 530 according to a coupling result between the mode pins 541 and the selection pins 641, so that the multiplex sensing core 500 only needs to enable some of the sensing units 530 corresponding to the buttons 630 and the side frame buttons 632 without having to enable all the sensing units 530, thereby effectively reducing power consumption.

Furthermore, since different input device housings have different selection pins, the multiplex sensing core 500 of the present embodiment may be applied to various different input device housings, and the current input mode can be determined according to a currently coupled state of the mode pins 541. In this regard, the user only needs to replace the input device housing 600 with other input device housings, and different manipulation and input functions can be provided by the multiplex sensing core 500.

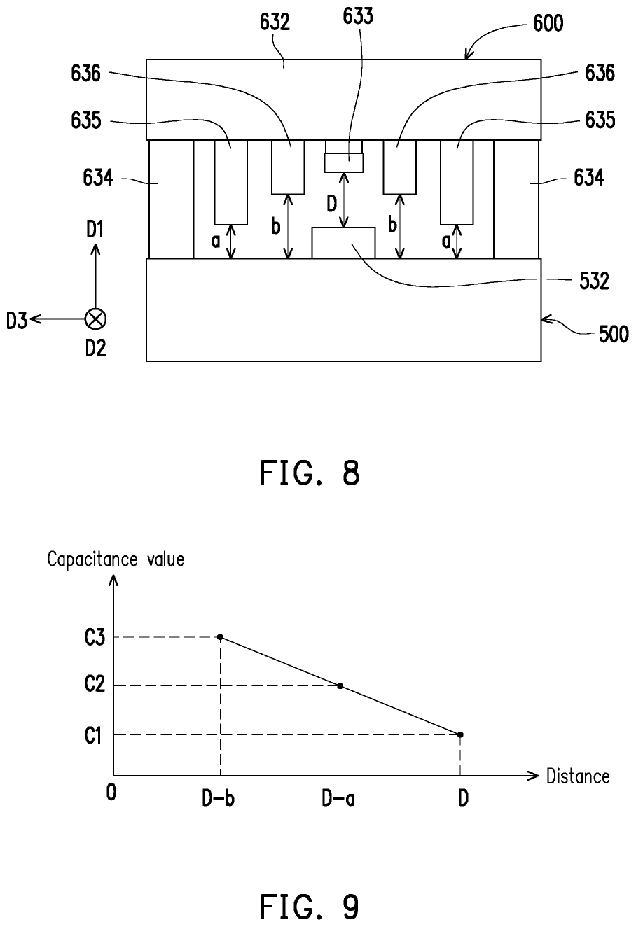

FIG. 8 is a schematic diagram of a structure of a side frame button and a sensing unit according to the embodiment of FIG. 5 of the disclosure. FIG. 9 is a schematic diagram of a capacitance value variation according to the embodiment of FIG. 8 of the disclosure. Referring to FIG. 5, FIG. 8 and FIG. 9, the sensing unit 532 of the multiplex sensing core 500 is, for example, disposed on a side of a circuit board. The side frame button 632 may include an electrode 633 and support members 634, 635 and 636. The support members 634 and 635 are, for example, elastic support members. The support member 636 is, for example, a non-elastic support member. In the present embodiment, in the case where the user applies no pressure to the side frame button 632, the electrode 633 of the side frame button 632 and the sensing unit 532 of the multiplex sensing core 500 are held at a fixed distance apart from each other by the elastic support member 634, and the distance between the sensing unit 532 and the electrode 633 is D (in units of, for example, millimeter (mm)). In this regard, a sensing capacitance value between the sensing unit 532 and the electrode 633 is C1 (in units of, for example, picofarad (pF)).

In one embodiment, in the case where the user applies less pressure to the side frame button 632, the distance between the electrode 633 of the side frame button 632 and the sensing unit 532 of the multiplex sensing core 500 is reduced to D-a. In this regard, the sensing capacitance value between the sensing unit 532 and the electrode 633 is C2, and a capacitance value variation is C2-C1. In another embodiment, in the case where the user applies larger pressure to the side frame button 632, the distance between the electrode 633 of the side frame button 632 and the sensing unit 532 of the multiplex sensing core 500 is reduced to D-b (wherein b>a). In this regard, the sensing capacitance value between the sensing unit 532 and the electrode 633 is C3, and the capacitance value variation is C3-C1.

In other words, the side frame button 632 of the present embodiment may be designed to include the support members 635 and 636 of two different heights. In the present embodiment, the microcontroller of the multiplex sensing core 500 may determine the degree of force applied to the side frame button 632 according to the capacitance value variation between the sensing unit 532 and the side frame button 632, and the capacitance value between the sensing unit 532 and the side frame button 632 increases as the distance between the sensing unit 532 and the side frame button 632 decreases.

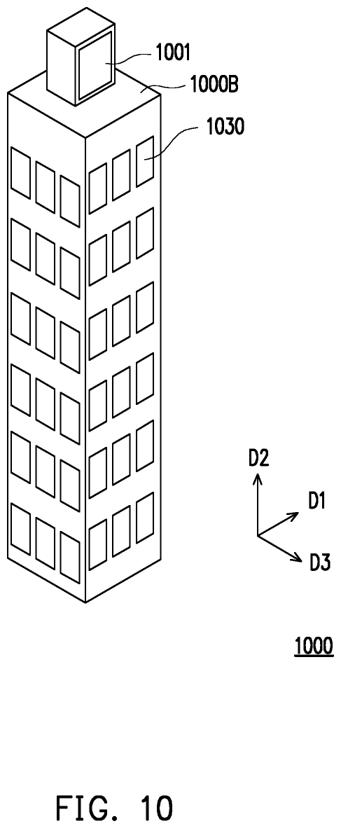

FIG. 10 is a schematic diagram of a multiplex sensing core according to another embodiment of the disclosure. Referring to FIG. 10, in the present embodiment, a multiplex sensing core 1000 may include a core column 1000B, and a sensing unit array formed by a plurality of sensing units 1030 may be disposed surrounding the core column 1000B. A connector 1001 of the multiplex sensing core 1000 may be combined with a connector of an input device housing. In other words, the multiplex sensing core 1000 of the present embodiment may have a multi-sided (four-sided) sensing function and can effectively reduce the volume of the multiplex sensing core. In addition, sufficient teaching, suggestions and descriptions for implementation regarding other internal circuit elements, structural features and implementation details of the multiplex sensing core 1000 of the present embodiment may be obtained from the above embodiments of FIG. 1 to FIG. 9, and thus, details thereof will not be described herein.

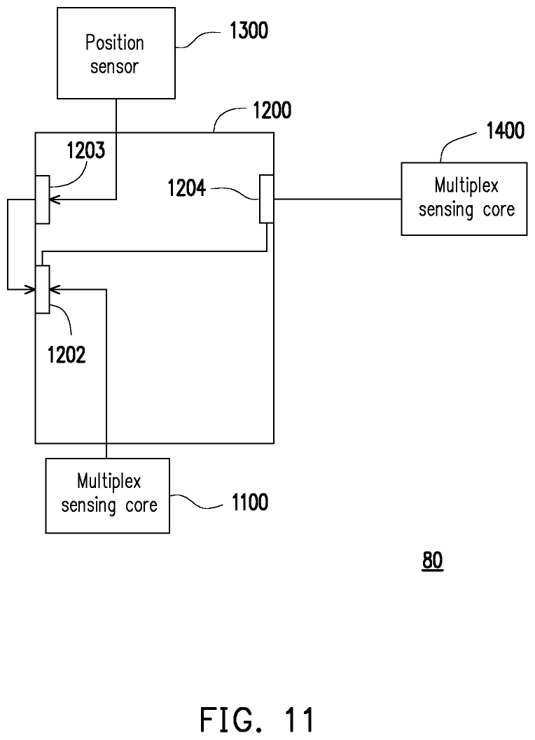

FIG. 11 is a schematic block diagram of an input device according to another embodiment of the disclosure. Referring to FIG. 11, an input device 80 includes multiplex sensing cores 1100 and 1400, an input device housing 1200, and a position sensor 1300. In the present embodiment, the input device 80 may combine the multiplex sensing cores 1100 and 1400 by the specific input device housing 1200 to implement more operation mechanisms. In the present embodiment, the multiplex sensing cores 1100 and 1400 may be incorporated into the input device housing 1200. The multiplex sensing core 1100 may be coupled to a connector 1202 of the input device housing 1200. The multiplex sensing core 1400 may be coupled to a connector 1203 of the input device housing 1200. The position sensor 1300 may be coupled to a connector 1204 of the input device housing 1200. The connector 1202 may be coupled to the connector 1203 and the connector 1204, respectively, so that the multiplex sensing core 1100 communicates with the multiplex sensing core 1400 and the position sensor 1300. For example, the multiplex sensing core 1100 may serve as a primary processing unit to process positioning information provided by the position sensor 1300 and sensing information provided by the multiplex sensing core 1400. Moreover, the multiplex sensing core 1100 of the present embodiment may further include the circuit elements described in the above embodiments, and details thereof will not be described herein.

In addition, sufficient teaching, suggestions and descriptions for implementation regarding other internal circuit elements, structural features and implementation details of the multiplex sensing cores 1100 and 1400, the input device housing 1200 and the position sensor 1300 of the present embodiment may be obtained from the above embodiments of FIG. 1 to FIG. 10, and thus, details thereof will not be described herein.

In summary, in the multiplex sensing core and the input device of the disclosure, by disposing the sensing unit array on the multiplex sensing core, the multiplex sensing core can be selectively combined with different input device housings by the user. Moreover, the multiplex sensing core may further be combined with another multiplex sensing core to be incorporated into the same input device housing, so that the input device can provide more operation functions. Thus, the user may use the input device of the disclosure to implement more diverse manipulation mechanisms in a VR, AR or MR operating environment. Therefore, the multiplex sensing core and the input device of the disclosure can provide diverse input functions and manipulation effects, so as to provide a good user experience and even reduce the manufacturing cost of the input device.

Although the disclosure has been described with reference to the above examples, it will be apparent to one of ordinary skill in the art that modifications to the described examples may be made without departing from the spirit of the disclosure. Accordingly, the scope of the disclosure will be defined by the attached claims and not by the above detailed descriptions.

What is claimed is:

1. A multiplex sensing core adapted to be combined with an input device housing, wherein the multiplex sensing core comprises:
a sensing unit array comprising a plurality of sensing units;
a first combining mechanism configured to be combined with a second combining mechanism of the input device housing, so that at least one of the sensing units is disposed corresponding to a plurality of buttons of the input device housing; and
a microcontroller coupled to the sensing units and configured to enable the at least one of the sensing units corresponding to the buttons of the input device housing, and disable other sensing units that do not correspond to the buttons of the input device housing.

2. The multiplex sensing core according to claim 1, further comprising:
a mode selection unit coupled to the microcontroller and comprising a plurality of mode pins,
wherein the microcontroller determines to enable the at least one of the sensing units according to a coupling result between at least one of the mode pins and at least one selection pin of the input device housing.

3. The multiplex sensing core according to claim 2, further comprising:
a memory unit coupled to the microcontroller and configured to record a lookup table,
wherein the microcontroller reads the lookup table according to the coupling result between the at least one of the mode pins and the at least one selection pin of the input device housing, so as to determine to enable the at least one of the sensing units.

4. The multiplex sensing core according to claim 1, further comprising:
a first connector, wherein when the multiplex sensing core is combined with the input device housing, the first connector is coupled to a second connector of the input device housing, and the second connector of the input device housing is coupled to a third connector of a position sensor, so that the microcontroller drives the position sensor.

5. The multiplex sensing core according to claim 1, further comprising:
another sensing unit coupled to the microcontroller, wherein when the multiplex sensing core is combined with the input device housing, the other sensing unit is disposed corresponding to a side frame button of the input device housing.

6. The multiplex sensing core according to claim 5, wherein the microcontroller determines a degree of force applied to the side frame button according to a capacitance value variation between the other sensing unit and the side frame button.

7. The multiplex sensing core according to claim 1, further comprising:
a core column, wherein a plurality of sensing unit arrays are disposed surrounding the core column.

8. The multiplex sensing core according to claim 1, further comprising:
a plurality of light emitting units coupled to the microcontroller and disposed corresponding to the sensing units.

9. The multiplex sensing core according to claim 1, wherein when the input device housing is combined with both the multiplex sensing core and another multiplex sensing core, the microcontroller determines an input mode according to corresponding disposition between the at least one of the sensing units of the multiplex sensing core and the buttons of the input device housing and between at least one of another plurality of sensing units of the other multiplex sensing core and another plurality of buttons of the input device housing.

10. The multiplex sensing core according to claim 1, further comprising:
a communication unit coupled to the microcontroller,
wherein the microcontroller communicates with an external reality apparatus via the communication unit, and, according to an operation result of the buttons of the input device housing corresponding to the at least one of the sensing units, outputs an operation command to the reality apparatus.

11. An input device comprising:
a multiplex sensing core comprising:
a sensing unit array comprising a plurality of sensing units;
a first combining mechanism; and
a microcontroller coupled to the sensing units; and
an input device housing comprising:
a plurality of buttons; and
a second combining mechanism;
wherein the first combining mechanism of the multiplex sensing core is combined with the second combining mechanism of the input device housing, so that at least one of the sensing units is disposed corresponding to the buttons, and the microcontroller enables the at least one of the sensing units corresponding to the buttons and disables other sensing units that do not correspond to the buttons.

12. The input device according to claim 11, wherein the multiplex sensing core further comprises:
a mode selection unit coupled to the microcontroller and comprising a plurality of mode pins,
wherein the microcontroller determines to enable the at least one of the sensing units according to a coupling result between at least one of the mode pins and at least one selection pin of the input device housing.

13. The input device according to claim 12, wherein the multiplex sensing core further comprises:
a memory unit coupled to the microcontroller and configured to record a lookup table,
wherein the microcontroller reads the lookup table according to the coupling result between the at least one of the mode pins and the at least one selection pin of the input device housing, so as to determine to enable the at least one of the sensing units.

14. The input device according to claim 11, wherein the multiplex sensing core further comprises:
a first connector, wherein when the multiplex sensing core is combined with the input device housing, the first connector is coupled to a second connector of the input device housing, and the second connector of the input device housing is coupled to a third connector of a position sensor, so that the microcontroller drives the position sensor.

15. The input device according to claim 11, wherein the multiplex sensing core further comprises:
another sensing unit coupled to the microcontroller, wherein when the multiplex sensing core is combined with the input device housing, the other sensing unit is disposed corresponding to a side frame button of the input device housing.

16. The input device according to claim 15, wherein the microcontroller determines a degree of force applied to the side frame button according to a capacitance value variation between the other sensing unit and the side frame button.

17. The input device according to claim 11, wherein the multiplex sensing core further comprises:
a core column, wherein a plurality of sensing unit arrays are disposed surrounding the core column.

18. The input device according to claim 11, wherein the multiplex sensing core further comprises:
a plurality of light emitting units coupled to the microcontroller and disposed corresponding to the sensing units.

19. The input device according to claim 11, wherein when the input device housing is combined with both the multiplex sensing core and another multiplex sensing core, the microcontroller determines an input mode according to corresponding disposition between the at least one of the sensing units of the multiplex sensing core and the buttons of the input device housing and between at least one of another plurality of sensing units of the other multiplex sensing core and another plurality of buttons of the input device housing.

20. The input device according to claim 11, wherein the multiplex sensing core further comprises:
a communication unit coupled to the microcontroller,
wherein the microcontroller communicates with an external reality apparatus via the communication unit, and, according to an operation result of the buttons of the input device housing corresponding to the at least one of the sensing units, outputs an operation command to the reality apparatus.
